(19) United States
(12) Patent Application Publication
(10) Pub. No.: US 2017/0338527 A1
(43) Pub. Date: Nov. 23, 2017

(54) THERMAL MALFUNCTION DETECTOR FOR ELECTRIC VEHICLE

(71) Applicant: Faraday&Future Inc., Gardena, CA (US)

(72) Inventor: Brandon Emerson William Walton, Ontario (CA)

(21) Appl. No.: 15/160,861

(22) Filed: May 20, 2016

(51) Int. Cl. H01M 10/48; H01M 10/613; H01M 10/625; H01M 10/6568

(52) U.S. Cl. CPC H01M 10/482; H01M 10/6568; H01M 10/488; H01M 10/613; H01M 10/625; H01M 2220/20

(57) ABSTRACT

Systems, devices, and methods for thermal malfunction detection in a liquid cooled vehicle battery are disclosed herein. Systems can include a housing enclosing at least a portion of one or more electrochemical cells, a flow path at least partially disposed within the housing and at least partially in thermal contact with at least a portion of the one or more electrochemical cells, and a thermal malfunction detector disposed at least partially within the flow path. The thermal malfunction detector can be capable of detecting matter output by the one or more electrochemical cells during a thermal malfunction. Matter output during a thermal malfunction may include smoke.

### BACKGROUND

### Field

This disclosure relates to battery protection systems and, more specifically, to systems and methods for battery thermal malfunction detection in liquid-cooled battery systems. In particular, devices, systems, and methods for detecting battery failure in an electric vehicle are disclosed.

### Description of the Related Art

Electric vehicles generally use one or more electric motors for propulsion and are powered by a battery system. Such vehicles include road and rail vehicles, surface and underwater vessels, electric aircraft, and electronic recreational devices. Electric vehicles release zero air pollutants and generate less noise than conventional combustion engine vehicles. Currently, lithium-ion batteries are often used. Overheating lithium-ion batteries may present a fire hazard, necessitating protection systems to detect thermal malfunction and stop lithium-ion batteries from charging or discharging when overheated.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In one embodiment, a battery thermal malfunction detection system is described. The system may include a housing enclosing at least a portion of one or more electrochemical cells, a flow path at least partially disposed within the housing, and a thermal malfunction detector disposed at least partially within the flow path. At least a portion of the flow path may be in thermal contact with at least a portion of the one or more electrochemical cells. The thermal malfunction detector may be capable of detecting matter output by the one or more electrochemical cells during a thermal malfunction. The thermal malfunction detector may be a smoke detector. The thermal malfunction detector may be a liquid particle counter. The flow path may include a coolant reservoir, and the thermal malfunction detector may be located at least partially within the coolant reservoir. The thermal malfunction detector may be located at least partially within a fluid-free region of the flow path. The thermal malfunction detector may be located at least partially within a fluid-free region of the coolant reservoir. The thermal malfunction detector may be at least partially immersed in a coolant.

The housing and the thermal malfunction detector may be located within an electric vehicle. The electric vehicle may further include at least one electric motor and the one or more electrochemical cells may be configured to provide power to the electric motor. The one or more electrochemical cells may be electrically connected in parallel to form a plurality of battery modules, and the plurality of battery modules may be electrically connected in series to form a string. A pump may be coupled to the flow path and configured to move coolant through the flow path. The one or more electrochemical cells may include a plurality of strings, each string having at least one thermal malfunction detector.

The thermal malfunction detector may be configured to generate an alert when a thermal malfunction is detected. A system of the electric vehicle may be configured to notify a user of the vehicle at least partially based on the alert. A system of the electric vehicle may be configured to disconnect at least one of the one or more electrochemical cells from the at least one electric motor at least partially based on the alert.

In another embodiment, a method of detecting a thermal malfunction of a battery in an electric vehicle having one or more liquid cooled batteries is described. The method may include detecting smoke or other particulate matter within a coolant flow path of the liquid cooled batteries, and generating an alert in response to the detection of smoke or other particulate matter. The method may further include notifying a user of the vehicle based on the alert. The method may further include disconnecting at least one of the one or more electrochemical cells from one or more motors of the electric vehicle based on the alert.

In another embodiment, a system for detecting battery malfunction is described. The system may include a plurality of electrochemical cells, heat transfer means in thermal contact with at least a portion of the plurality of electrochemical cells, containing means configured to contain the heat transfer means, and means for detecting a thermal malfunction disposed within the containing means. The means for detecting a thermal malfunction may be capable of detecting matter output by one or more of the plurality of electrochemical cells during a fire. The means for detecting a thermal malfunction may be capable of detecting smoke.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a block diagram depicting an arrangement and operation of a liquid cooled battery with a thermal malfunction detector in accordance with an exemplary embodiment.

FIG. 2 depicts a configuration of a liquid cooled battery with a thermal malfunction detector in accordance with an exemplary embodiment.

FIG. 3 is a simplified diagram depicting a chassis of an electric vehicle incorporating thermal malfunction detection in accordance with an exemplary embodiment.

FIG. 4 is a simplified diagram depicting multiple battery strings within an electric vehicle in accordance with an exemplary embodiment.

### DETAILED DESCRIPTION OF THE PREFERRED EMBODIMENT

The following description is directed to certain implementations for the purpose of describing the innovative aspects of this disclosure. However, a person having ordinary skill in the art will readily recognize that the teachings herein can be applied in a multitude of different ways. The described implementations may be implemented in any electrical circuit. In some implementations, the word “battery” or “batteries” will be used to describe certain elements of the embodiments described herein. It is noted that “battery” does not necessarily refer to only a single battery cell. Rather, any element described as a “battery” or illustrated in the Figures as a single battery cell in a circuit may equally be made up of any larger number of individual battery cells and/or other elements, or may be a single module within a larger battery structure, without departing from the spirit or scope of the disclosed systems and methods. The term “flow path” or “coolant flow path” will also be used to describe certain elements of the embodiments described herein. It is noted that a “flow path” or “coolant flow path” refers to any structure or combination of structures configured to contain, accommodate, and/or direct a liquid or gaseous coolant. For example, a “flow path” or “coolant flow path” can include conduits, a coolant reservoir, heat exchanger, coolant pump, a battery housing or portion thereof configured for the passage of coolant therethrough, and/or other structure of a battery or coolant system. Moreover, a “flow path” need not be in constant or occasional contact with a coolant. For example, an upper portion of a coolant reservoir which may rarely or never come into contact with a liquid coolant within the cooling system, may still be referred to as a portion of the flow path.

One or more batteries may use a liquid coolant to maintain appropriate operating temperatures. For example, one or more batteries may be enclosed by a housing and surrounded by liquid coolant. In some embodiments, coolant or cooling liquid or cooling fluid may include, for example, one or more of the following: synthetic oil, polyolefin (e.g., poly-alpha-olefin (“PAO”)), ethylene glycol, ethylene glycol and water, and phase change materials (“PCM”). In some aspects, battery cooling systems employ liquid dielectrics as the coolant. In some embodiments, battery cooling systems may use air or other gaseous coolants. Gaseous coolants may similarly be circulated and enclosed by a housing. The coolant may be configured to transfer heat from the gaseous or liquid coolant to the housing. The housing may include one or more heat sinks. In some embodiments, liquid may be circulated through the housing and/or through a coolant reservoir and/or heat exchanger.

Thermal malfunction may include overheating, which may cause the emission of particulate matter, smoke, liquids, battery components, or other materials, melting of materials, and/or physical damage to the battery sufficient to cause the battery components to leak into the coolant flow path. In some aspects, a thermal malfunction may include conditions such as short-circuiting, thermal runaway, or other abnormal conditions. Thermal malfunction of battery cells in a liquid cooled system may be detected based on the temperature of the coolant. The overall temperature of the coolant may be measured, for example, as the coolant is removed from the battery pack. An increase in the overall temperature of the coolant may indicate that a thermal malfunction is occurring in one or more electrochemical cells of the battery pack. In some cases, temperature sensors may be located at various locations within the battery pack and/or near the cells in order to detect local coolant temperature increases that may not increase the overall coolant temperature enough to be detected. Even with multiple temperature sensors, it may be difficult or impossible to detect thermal malfunctions of individual cells because a single cell's failure may not raise the temperature of the coolant enough to be detectable and/or trigger an alert. Using a separate dedicated temperature sensor for each individual battery cell may be impractical, especially in implementations having hundreds of individual cells. In some embodiments, battery failure may also be detected by, for example, monitoring the current and/or voltage output by a battery, battery pack, or battery string. However, such detection methods may be inadequate to detect the failure of a single battery cell or a small number of battery cells, as the failure of a small number of cells may not have a large effect on the overall current and/or voltage output by a large number of batteries containing the failed batteries.

A thermal malfunction of a battery cell or other battery pack component may produce smoke and/or other output matter, which may propagate through the cooling system either dissolved in the coolant or in fluid-free regions. Typically, any smoke present in the cooling system will accumulate at a high point and/or in a fluid-free region, such as the upper portion of a coolant reservoir within the system. Even a single malfunctioning cell that cannot trigger a coolant temperature alert may produce sufficient smoke and/or other malfunction-related output matter to be detectable.

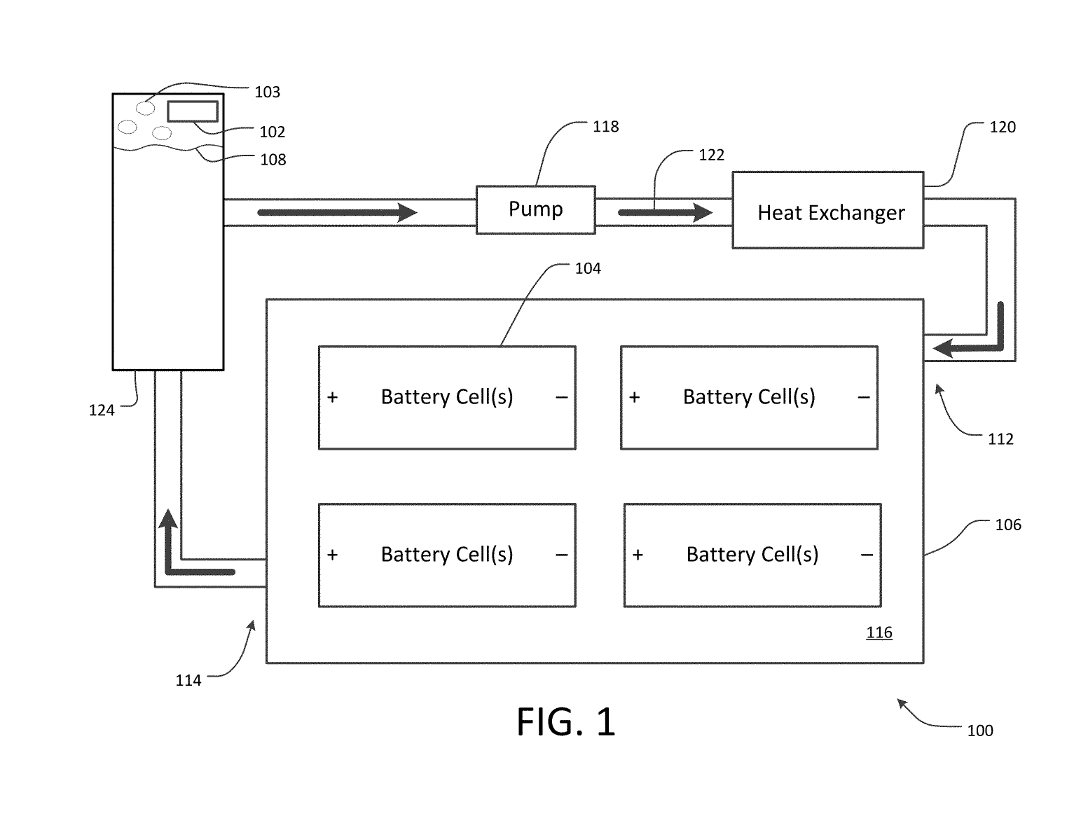

FIG. 1 is a block diagram depicting an arrangement and operation of a liquid cooled battery 100 with a thermal malfunction detector 102 in accordance with an exemplary embodiment. A battery 100 may include one or more electrochemical cells 104 disposed within a housing 106. The one or more electrochemical cells 104 may be connected electrically with battery terminals (not shown), where connections may be made to power vehicle systems, such as lights, powertrain, climate control, braking assist, or any other vehicle system capable of using electrical power. The one or more electrochemical cells 104 may be electrically connected in parallel and/or in series as desired.

A battery 100 may further include a coolant flow path including a coolant intake 112 and a coolant exit 114. An external cooling system may introduce coolant liquid into the space 116 inside the housing 106 through the coolant intake 112. Coolant may be stored in a portion of the flow path such as an external coolant reservoir 124. The coolant may be drawn out of the reservoir based on a negative pressure created by a pump 118 of the cooling system. The coolant may be sent along the flow path through a heat exchanger 120 and proceed into the space 116 within the battery housing 106 at the coolant intake 112. Coolant entering the space 116 may circulate within the space 116, collecting thermal energy created by the operation of cells 104 as it passes. After exiting the space 116 through the coolant exit 114, liquid coolant may return to the coolant reservoir 124, and the cooling process may repeat indefinitely.

In some embodiments, a battery housing 106 may be configured so as to allow coolant to flow through only a portion of the housing 106. For example, the housing 106 may include internal structures and/or flow path components (not shown) directing and/or containing the flow of coolant. As shown in FIG. 1, coolant may flow around all sides of the individual cells. However, in some embodiments, coolant may be limited to contacting a side portion of the electrochemical cells 104, while the portion of the housing 106 containing other circuitry may be kept dry. Generally, any portion of the battery system configured to contain and/or direct the flow of coolant, such as the battery housing 106 and/or internal coolant conduit structures (not shown) may be referred to as a portion of a cooling system and/or a portion of the coolant flow path. In general however, smoke or other particulate matter may exit the one or more cells and enter into the coolant flow path.

The reservoir 124 may function as a reserve tank to store a portion of the coolant liquid that is not circulating within the housing 106, pump 118, heat exchanger 120, or the connecting conduits. Some coolant liquids may experience significant thermal expansion and contraction during cooling system operation. Thus, the reservoir 124 may contain excess volume to function as a surge tank, allowing the coolant to expand and contract freely. As the coolant changes in volume over time, the fluid level 108 within the reservoir may fluctuate. The space above the fluid level 108 within the reservoir 124 may contain air and/or any other gas. For example, the volume of the reservoir 124 not occupied by coolant liquid may contain ambient air that entered the cooling system any time the reservoir 124 or other part of the cooling system was opened to add or remove coolant or to check the quantity and/or condition of the liquid. In some embodiments, the upper portion of the reservoir 124 may be a high point of the cooling system, such that any air or other gas within the circulating coolant, such as bubbles within the coolant, may be retained in the upper portion of the reservoir 124 rather than returning to the other portions of the cooling system.

If any of the electrochemical cells 104 within the housing 106 experiences a thermal malfunction, it may produce smoke 103 or other output matter. Similarly, other electrical components within the housing 106 and/or the cooling system may produce smoke 103 when malfunctioning, for example, due to resistive heating or burning out of electrical components. If a thermal malfunction is severe enough to cause an electrochemical cell 104 to partially break down, the output matter may include pieces or particles of the battery materials (e.g., electrolyte, polymer separator, anode, cathode, and/or constituent materials or breakdown products of battery components). In some thermal malfunction events, gases such as ethane, methane, and/or oxygen may be released.

Such smoke 103 and/or other output matter may be carried through the cooling system surrounded by or dissolved in the coolant in the coolant flow path until the smoke 103 or other output matter reaches the reservoir 124. At the reservoir 124, smoke 103 or other gases or particles may cross the fluid level 108 and accumulate in the air volume above. Eventually, enough output matter such as smoke 103 may accumulate within the reservoir to be detectable by a thermal malfunction detector, such as a smoke detector 102. In some embodiments, the thermal malfunction detector 102 may be located at or near the top of the reservoir 124, so as to remain within the fluid-free space above the fluid level 108 where smoke or other non-fluid matter is most likely to accumulate. The thermal malfunction detector 102 may be any suitable smoke and/or particulate matter detecting device. For example, the detector 102 may be a smoke detector such as an optical smoke detector, ionization smoke detector, photoelectric smoke detector, or the like. In some embodiments, the detector 102 may be capable of detecting any of various gases produced by battery thermal malfunction, such as hydrocarbon gases, oxygen or other gas. In some embodiments, the detector 102 may be a liquid particle counter or other detector capable of detecting particulate matter within the fluid.

When smoke, other gas, or other output matter is present in sufficient quantity to be detected at the detector 102, the detector 102 may produce an alert. For example, the alert may be sent to a battery management system (not shown). The battery management system may include circuitry configured to receive the alert from the detector 102 and take appropriate remedial action, such as disconnecting the battery, battery module, or group of battery modules containing the thermally malfunctioning cell 104 in order to discontinue charging or discharging of the battery. In some embodiments, the detector 102 or battery management system may notify a user, such as a vehicle driver, that a thermal malfunction has been detected and/or that battery service is required. The alert may include an audio alert that is audible to the user and/or a visual alert that is displayed in an area that is readily apparent to the user (e.g. dashboard or video display).

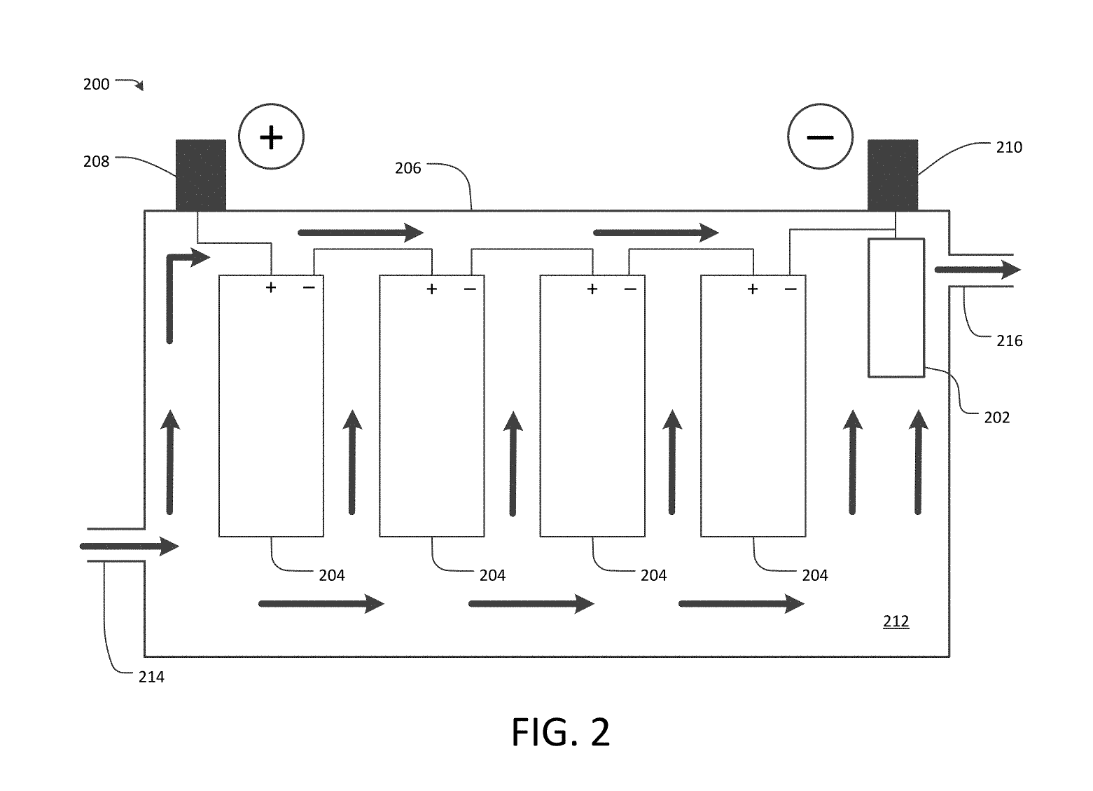

FIG. 2 depicts a configuration of a liquid cooled battery 200 with a thermal malfunction detector 202 in accordance with an exemplary embodiment. In some embodiments, a thermal malfunction detector 202 may be located within a coolant flow path or fluid-filled region, such as within the battery housing 206. Thus, the thermal malfunction detector 202 may be in at least partial contact with the coolant flow path. The liquid cooled battery 200 may include a plurality of electrochemical cells 204 disposed within a battery housing 206. In some embodiments, electrochemical cells 204 may be connected in series, in parallel, or in a combination of series and parallel connections. Although the configuration of FIG. 2 depicts four cells 204 connected in series, the systems and processes described herein may readily be applied to more complex arrangements of cells 204. For example, a battery 200 may include a plurality of serially connected sets or strings of parallel cells 204, rather than serially connected individual cells 204, so as to provide additional energy storage capacity without increasing the battery voltage.

The thermal malfunction detector 202 may be located in the space 212 within the battery housing 206 so that coolant within the space 212 may circulate around both the electrochemical cells 204 and the thermal malfunction detector 202. Similar to the configuration described with reference to FIG. 1 above, liquid coolant may enter the space 212 at a coolant intake 214 and leave the space 212 at a coolant exit 216. Coolant may flow freely throughout the space 212, passing around and between the plurality of electrochemical cells 204 and the thermal malfunction detector 202 before leaving at coolant exit 216, as indicated by bold arrows in FIG. 2. A thermal malfunction detector 202 configured to operate while immersed in a coolant may be any type of particle detector suitable for detecting particles in a fluid. For example, thermal malfunction detector 202 may be a liquid particle counter or the like. A thermal malfunction detector 202 may detect particles within the fluid based on detection of light blocking, light scattering, imaging, or other suitable method. A thermal malfunction detector 202 may additionally detect smoke or other gaseous thermal malfunction products using any of the methods described elsewhere herein with reference to FIG. 1.

If the thermal malfunction detector 202 detects sufficient smoke or other thermal malfunction-related matter to indicate a thermal malfunction, the battery 200 may be disconnected in order to avoid further damage. For example, in some embodiments the detector 202 may be directly connected to the battery circuit, such as by a switch or other disconnecting means. When a thermal malfunction is detected, the detector 202 may be capable of opening the battery circuit to stop current flow. Thus, a thermally malfunctioning cell 204 may be prevented from continuing to charge or discharge, preventing or reducing further damage to the battery 200 from overheating or thermal runaway.

In some embodiments, the location of the detector 202 within the battery housing 206 may be selected so as to enhance the effectiveness of thermal malfunction-related particle detection. For example, the detector 202 may be located near the coolant exit 216 such that most of the coolant leaving the housing 206 passes through the immediate vicinity of the detector 202. Similarly, a detector 202 may be located within a coolant intake 214 or coolant exit 216, or within any other conduit of a cooling system as depicted in FIG. 1.

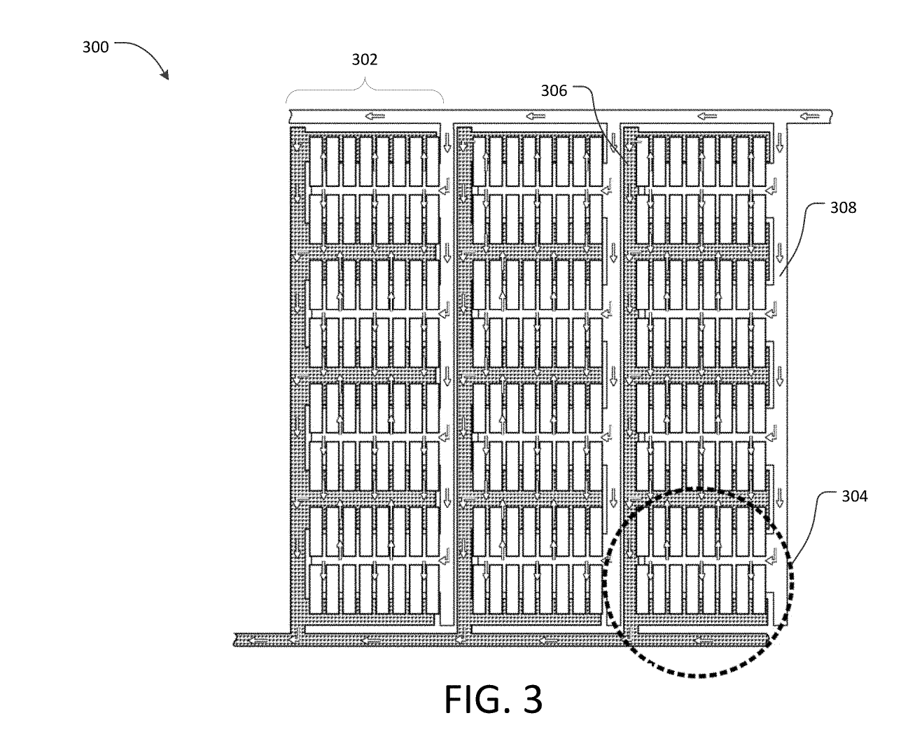

FIG. 3 is a diagram depicting multiple battery strings 302 within an electric vehicle battery pack 300 in accordance with an exemplary embodiment. In some embodiments, multiple batteries may be packaged in a module 304, with multiple modules 304 combined to form a battery pack 300. The individual batteries or battery modules 304 may be arranged in strings 302. A battery or battery module 304 may include one or more electrochemical cells. For example, each battery module 304 may comprise one or more batteries as described and depicted above with reference to FIGS. 1 and 2. The batteries may comprise any type of battery suitable for electric vehicle propulsion, such as lithium-ion batteries, nickel metal hydride batteries, lead acid batteries, or the like. In some embodiments, battery pack 300 may be a high voltage battery pack configured to power an electric vehicle powertrain. In some embodiments, battery pack 300 may be a low voltage (e.g., 12V) battery pack configured to power various electric vehicle systems.

A battery string 302 may be formed by connecting two or more battery modules 304 in series. Multiple strings 302 may be combined in parallel to create larger battery pack 300. Connecting multiple strings 302 in parallel allows for additional energy storage without increasing the voltage of the battery pack 300. For example, the battery pack 300 depicted in FIG. 3 may comprise up to six or more strings 302 of identical voltage and energy storage capacity (for clarity, only three strings are depicted). Thus, the energy storage capacity of the entire battery pack 300 is equal to six times the storage capacity of an individual string 302, while the voltage of the entire battery pack 300 is equal to the voltage of each individual string 302. The use of battery strings 302 allows for the addition of more strings 302 to add extra energy storage capacity to the battery pack 300 without affecting the voltage produced. Each string may include hundreds of individual electrochemical battery cells.

In embodiments combining multiple battery modules 304, liquid cooling may be performed in the same manner as described above with reference to FIGS. 1 and 2. In some embodiments, a single cooling system, including a coolant reservoir, pump, and heat exchanger, may be used to provide chilled coolant through multiple battery modules 304, multiple strings 302, or even an entire battery pack 300. Conduits 306 and 308 may be provided throughout the battery pack 300 to transport coolant between battery modules 304, strings 302, and other portions of the cooling system. In some embodiments, an intake conduit 306 may deliver chilled coolant to the battery modules 304, and a return conduit 308 may collect and return warmed coolant from the battery modules 304 to other portions of the cooling system.

Thermal malfunction detectors may be employed with a multi-battery pack 300 in the same manner as described above with reference to FIGS. 1 and 2. In some embodiments, a single thermal malfunction detector may be used for multiple battery modules 304. For example, where multiple batteries 304 are arranged in series in parallel strings 302, one thermal malfunction detector may be used for each string 302, rather than including a separate detector for each battery module 304.

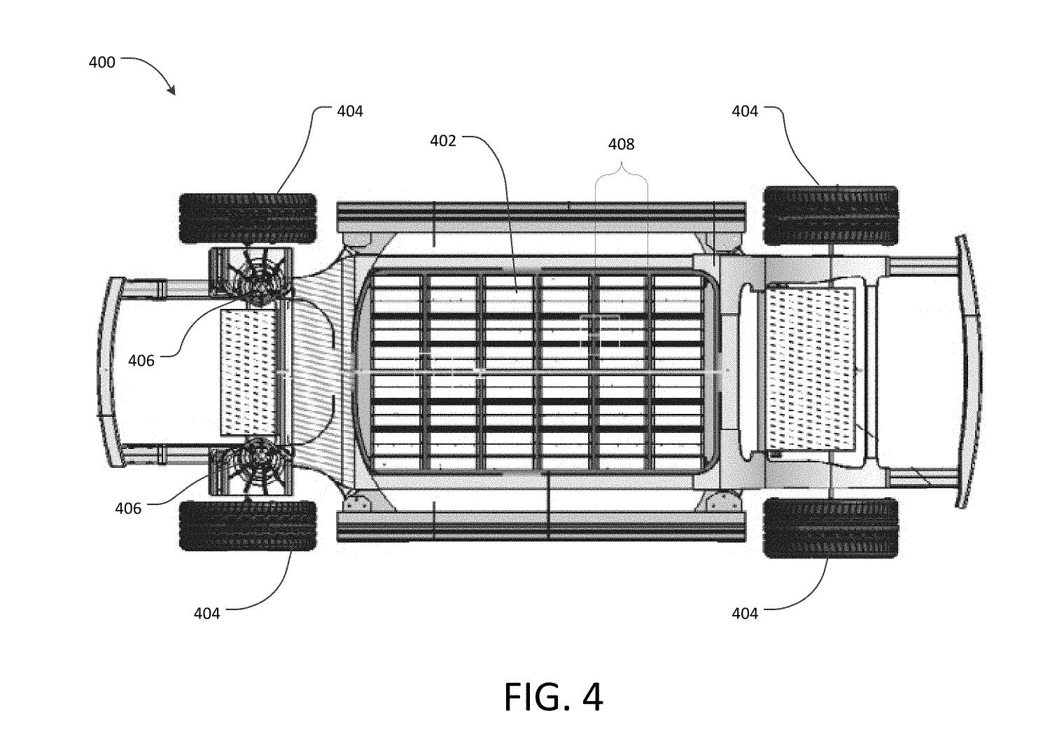

FIG. 4 is a diagram depicting a chassis of an electric vehicle 400 incorporating thermal malfunction detection in accordance with an exemplary embodiment. An electric vehicle 400 may include a powertrain comprising a battery pack 402, a plurality of wheels 404 and at least one electric traction motor 406 configured to turn the wheels 404 and propel the vehicle 400. The battery pack 402 may be configured to provide electric power to the traction motors 406. In some embodiments, the battery pack 402 may include multiple battery strings 408. Strings 408 may be individually switchable so that some strings 408 may be active and provide power while other strings 408 are disconnected from the rest of the vehicle. Individually switchable strings may improve performance and reliability, for example, by allowing the vehicle 400 to continue driving after a failure or fault detection in one or more strings 408, as the faulty string(s) may be disconnected while the remaining strings continue providing power.

Thermal malfunction detectors as described above with reference to FIGS. 1-3 may provide a similar benefit if used in each battery string 408. If a thermal malfunction occurs in any of the strings 408, it may be detected as described above. When a thermal malfunction is detected in one string 408, the string may be disconnected from the battery pack 402 circuit such as by a magnetic contactor or other switching device. When a string 408 is disconnected from the circuit, current stops flowing through that string 408, and the string 408 and/or individual electrochemical cells within the string 408 may be protected from further damage from the detected thermal malfunction.

Additional details and embodiments relating to the use of liquid cooled batteries in electric vehicles are described in U.S. application Ser. No. 14/841,617, titled “Vehicle Energy-Storage System” and filed on Aug. 31, 2015, which is incorporated by reference herein in its entirety.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A battery thermal malfunction detection system comprising:
a housing enclosing at least a portion of one or more electrochemical cells;
a flow path at least partially disposed within the housing, at least a portion of the flow path in thermal contact with at least a portion of the one or more electrochemical cells; and
a thermal malfunction detector disposed at least partially within the flow path, the thermal malfunction detector capable of detecting matter output by the one or more electrochemical cells during a thermal malfunction.

2. The battery thermal malfunction detection system of claim 1, wherein the thermal malfunction detector is a smoke detector.

3. The battery thermal malfunction detection system of claim 1, wherein the thermal malfunction detector is a liquid particle counter.

4. The battery thermal malfunction detection system of claim 1, wherein the flow path includes a coolant reservoir and the thermal malfunction detector is located at least partially within the coolant reservoir.

5. The battery thermal malfunction detection system of claim 4, wherein the thermal malfunction detector is located at least partially within a fluid-free region of the coolant reservoir.

6. The battery thermal malfunction detection system of claim 4, wherein the thermal malfunction detector is located at least partially within a fluid-free region of the flow path.

7. The battery thermal malfunction detection system of claim 1, wherein the thermal malfunction detector is at least partially immersed in a coolant.

8. The battery thermal malfunction detection system of claim 1, wherein the housing and the thermal malfunction detector are located within an electric vehicle, wherein the electric vehicle further comprises at least one electric motor, and wherein the one or more electrochemical cells are configured to provide power to the electric motor.

9. The battery thermal malfunction detection system of claim 8, wherein the one or more electrochemical cells are electrically connected in parallel to form a plurality of battery modules, and wherein the plurality of battery modules are electrically connected in series to form a string.

10. The battery thermal malfunction detection system of claim 1, wherein a pump is coupled to the flow path and configured to move coolant through the flow path.

11. The battery thermal malfunction detection system of claim 9, wherein the one or more electrochemical cells comprise a plurality of strings, each string having at least one thermal malfunction detector.

12. The battery thermal malfunction detection system of claim 8, wherein the thermal malfunction detector is configured to generate an alert when a thermal malfunction is detected.

13. The battery thermal malfunction detection system of claim 12, wherein a system of the electric vehicle is configured to notify a user of the vehicle at least partially based on the alert.

14. The battery thermal malfunction detection system of claim 12, wherein a system of the electric vehicle is configured to disconnect at least one of the one or more electrochemical cells from the at least one electric motor at least partially based on the alert.

15. A method of detecting a thermal malfunction of a battery in an electric vehicle having one or more liquid cooled batteries, the method comprising:
detecting smoke or other particulate matter within a coolant flow path of the liquid cooled batteries; and
generating an alert in response to the detection of smoke or other particulate matter.

16. The method of claim 15, further comprising notifying a user of the vehicle based on the alert.

17. The method of claim 15, further comprising disconnecting at least one of the one or more electrochemical cells from one or more motors of the electric vehicle based on the alert.

18. A system for detecting battery malfunction comprising:
a plurality of electrochemical cells;
heat transfer means in thermal contact with at least a portion of the plurality of electrochemical cells;
containing means configured to contain the heat transfer means; and
means for detecting a thermal malfunction disposed within the containing means, the means for detecting a thermal malfunction capable of detecting matter output by one or more of the plurality of electrochemical cells during a fire.

19. The battery system of claim 18, wherein the means for detecting a thermal malfunction is capable of detecting smoke.
